(19) United States
(12) Patent Application Publication
(10) Pub. No.: US 2003/0206527 A1
(43) Pub. Date: Nov. 6, 2003

(54) Transmitting data between multiple computer processors

(75) Inventor: Ting Shing Yim, Victoria (AU)

Correspondence Address: JOHN R. LASTOVA, NIXON & VANDERHYE, PC, 1100 NORTH GLEBE ROAD, 8TH FLOOR, ARLINGTON, VA, 22201-4714, US

(73) Assignee: Telefonaktiebolaget LM Ericsson

(21) Appl. No.: 09/951,388

(22) Filed: Sep. 14, 2001

Related U.S. Application Data
(63) Continuation of application No. 09/051,124, filed on Oct. 16, 1998, now abandoned.
Application No. 09/051,124 is a 371 of international application No. PCT/AU96/00621, filed on Oct. 2, 1996.

(30) Foreign Application Priority Data
Oct. 2, 1995 (AU) PN 5737

(51) Int. Cl. H04L 12/28; H04J 3/14

(52) U.S. Cl. 370/238; 370/252; 370/403; 370/406

(57) ABSTRACT

A communications system and method is provided in which data is transmitted between a plurality of nodes (A, B, C, D) in a network comprising a closed loop configuration of one or more pairs of unidirectional transmission rings (1, 2) arranged to transmit data in opposite directions around the rings. Each node includes a respective message processor (5, 6) for each of the transmission rings (1, 2) and a host processor (60) linked to the message processors (5, 6). The traffic of data in each ring is dynamically monitored to obtain traffic information which is utilized by the message processors in accordance with a traffic control process to select one of the rings to transmit data from an originating node to a destination node. In the event of a fault in one of the rings, the other ring is utilized to transmit data at a reduced performance level while repairs are made to the faulty ring.

The present invention relates to a method and apparatus for transmitting data between multiple computer processors.

In modern data communications involving multiple computer processors there are two traditional problems. Firstly, there is the unacceptable loss of data transmission speed when two or more processors attempt to communicate with each other. Secondly, multiple processor systems often show a complete or substantial failure after the occurrence of a transmission line problem.

Prior art techniques for transmitting data between processors or nodes have proposed recovery mechanisms in the event of a fault occurring in a ring connecting the processors, wherein data messages to be transmitted are looped back at a particular node and directed to an unaffected ring by a physical connection to an unaffected link at the node. None of the prior art techniques suggests a way of monitoring the data traffic on each of the rings linking the processors to select an optimum route for data traffic to travel to its destination processor or node.

It is therefore desirable to provide for an increase in available capacity enabling data transmission at an acceptable rate between processors in a ring network, and to provide for the transmission of data messages along the most expeditious route from an originating processor to a destination processor.

According to one aspect of the invention there is provided a method of transmitting data between a plurality of nodes containing computer processors, said method including the steps of:

connecting the nodes by a plurality of unidirectional transmission rings such that each ring is in a closed loop configuration, said transmission rings being arranged to transmit data in alternately opposed directions around the rings between the processors;

dynamically monitoring the traffic of data in each ring to obtain traffic information in each ring; and

utilising said traffic information to select one of the rings to transmit data in accordance with certain criteria.

The rings may be arranged in a layered configuration preferably comprising one or more pairs of unidirectional rings with each pair of rings being arranged to transmit data in opposite directions.

Preferably, each node comprises a plurality of message processors, one for each transmission ring.

According to another aspect of the invention there is provided a communications system for transmitting data between a plurality of nodes in a network, comprising:

a closed loop configuration of two or more unidirectional transmission rings connecting the nodes, the transmission rings being arranged to transmit data between the nodes in alternately opposed directions around the rings;

each node including a respective message processor for each of the transmission rings;

wherein the message processors are programmed to select one of the rings to be used for transmitting a message from a node to another node in accordance with certain criteria.

Each node preferably includes a host processor which is linked to the message processors of the node.

When a data message is required to be transmitted from an originating node to a destination node, the host processor is preferably arranged to send the data message to each message processor associated with the originating node, and the message processors of the originating node select a ring on which the data is to be transmitted by utilizing the monitored information.

The traffic of data in each ring may be monitored to obtain information on any one or more of the following:

the available ring capacity;

the data flow rate or traffic loading on each ring; and

fault identification.

The message processors may perform their selection on the basis of information obtained from a look-up table. The look-up table may contain information about the number of ring links along which a data message has to travel along each ring between the nodes to reach its destination so that the shortest route for the data message can be determined. The look-up table may also contain information about the data flow rate or traffic loading on each ring. Thus when one ring contains a lot of traffic and is congested, another ring may be selected. The look-up table is preferably dynamically updated for each new data message to be sent. For this purpose, counting means may be provided for counting the number of messages queued for transmission at a node or nodes of the system.

In accordance with another advantageous feature, a method in accordance with the invention may include the steps of determining whether data to be transmitted is priority data containing priority information and selecting one of the rings to transmit the priority data so as to provide the most expeditious route for the data to reach a destination node.

Packets of data containing priority information may contain a flag in a priority field to enable a message processor to determine that the data packet contains priority information. Packets of data having priority and queued for transmission may be transmitted ahead of packets queued for transmission that do not have priority.

In accordance with a further advantageous feature of the invention, one ring may be selected to transmit data of a particular kind and all other data is arranged to be transmitted on the other ring of a ring pair or, where there are more than two rings, on the other rings of the system. This is particularly useful when there is a large amount of data for a particular task to be transmitted from one node to another.

The method and system of the present invention may include means for performing maintenance functions, such as fault detection means for detecting when faults occurs in the transmission rings. In accordance with a preferred feature of the invention, when a fault is detected in one of the transmission rings, the system is arranged to transmit data messages only on the ring or rings not affected by the fault. This is in contrast to prior art techniques in which data messages are looped back at a node by a physical correction and directed onto an unaffected ring.

In accordance with another preferred feature the method and system of the invention utilize Scalable Coherent Interface (SCI) technology. The “Scalable Coherent Interface” is described in IEEE Standard P1596-1992 and other publications including a paper entitled “The Scalable Coherent Interface and Related Standards Projects by David B. Gustavson (February 1992—IEEE Micro, pp 10-21). The nodes in the system of the present invention preferably include scalable coherent interfaces (SCIs) which provide bus services by transmitting packets of data on print-to-print unidirectional links between the nodes. By using SCI technology the number of nodes and number of transmission rings in the method and system may be conveniently increased at any time by the addition of further SCIs.

In order that the invention may be more readily understood a particular embodiment will now be described, by way of example only, with reference to the accompanying drawings wherein:

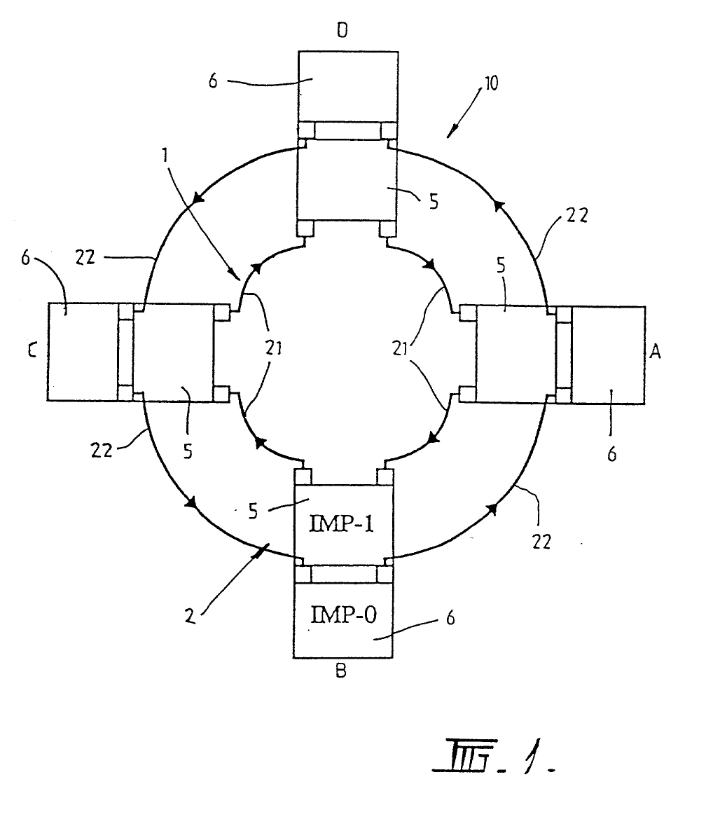

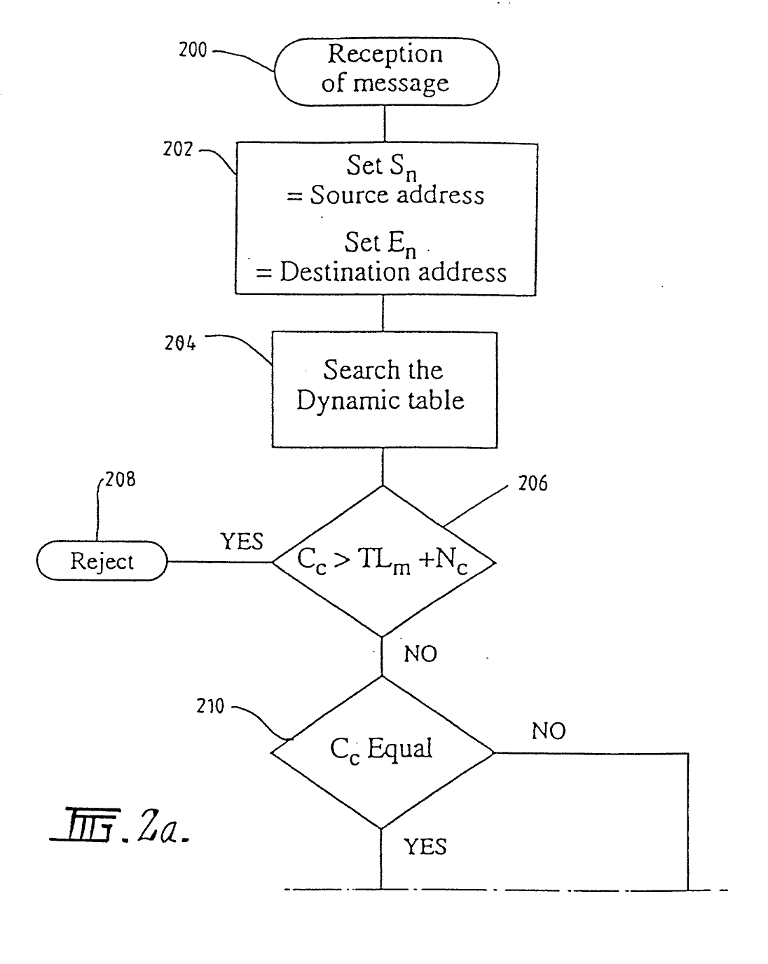

FIG. 1 is a schematic circuit block diagram of a communications system in accordance with the invention;

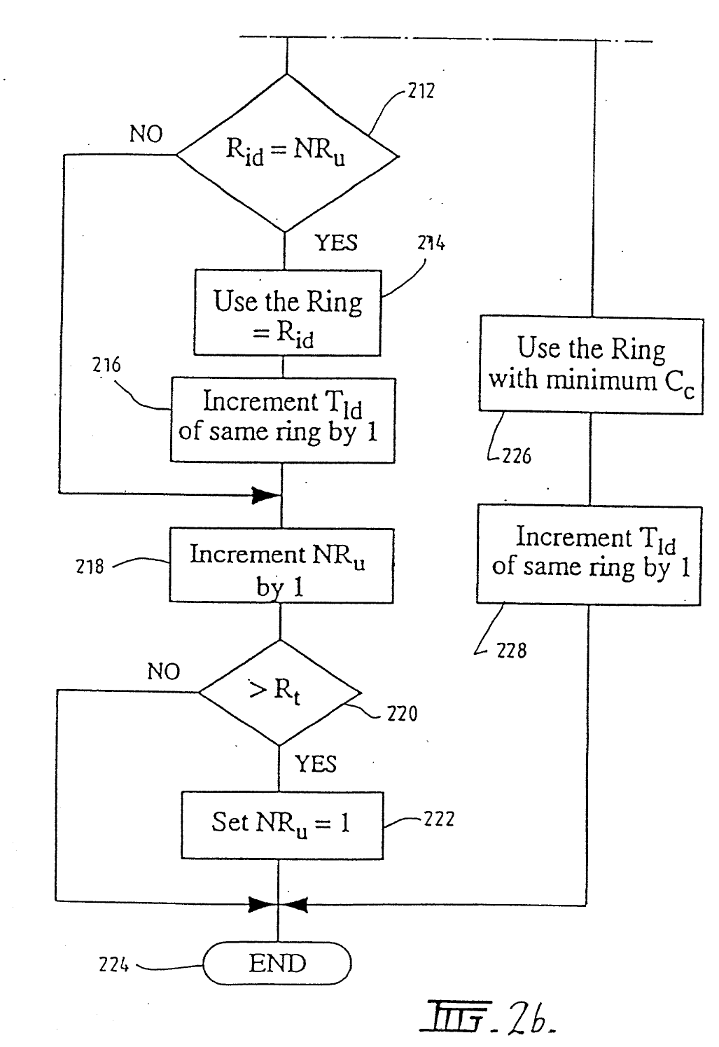

FIG. 2 is a flow chart of a traffic control process used in the invention;

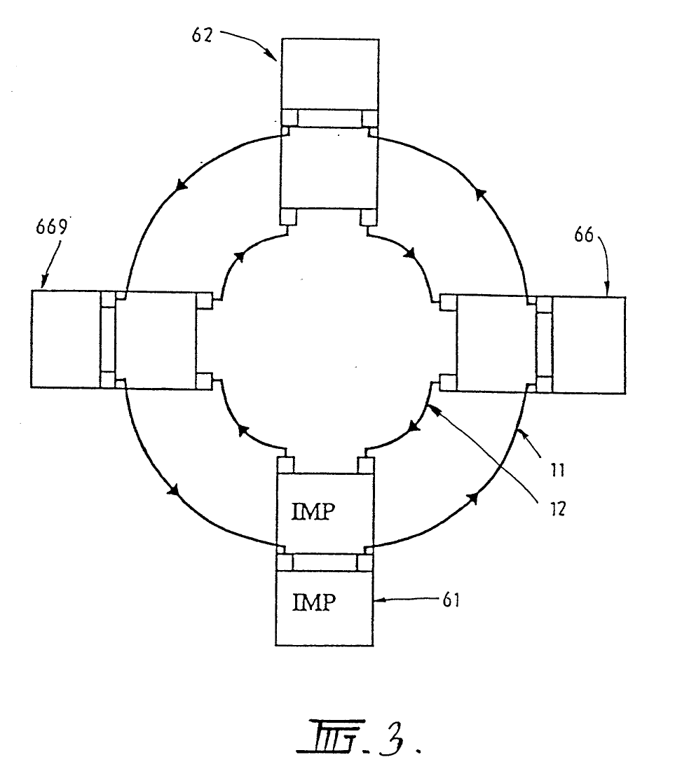

FIG. 3 is a particular example of the diagram of FIG. 1;

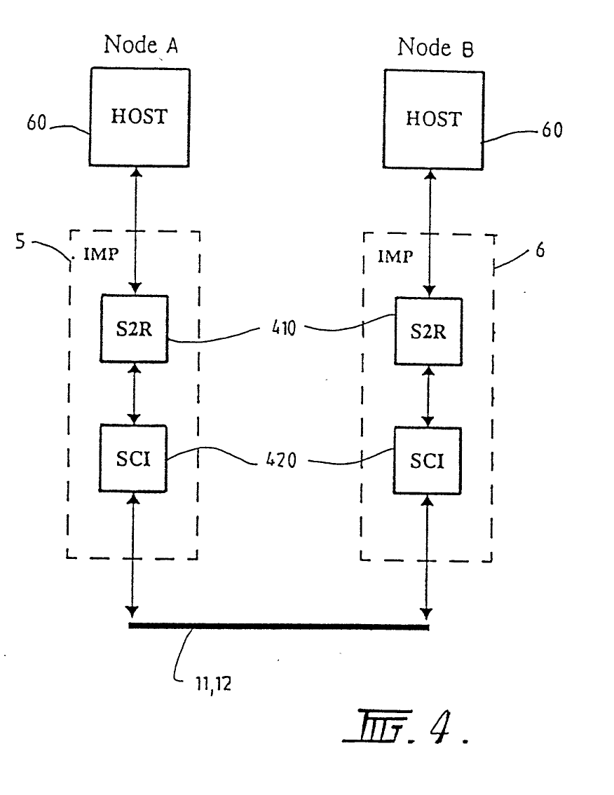

FIG. 4 is a schematic block diagram showing the maintenance functions associated with a node;

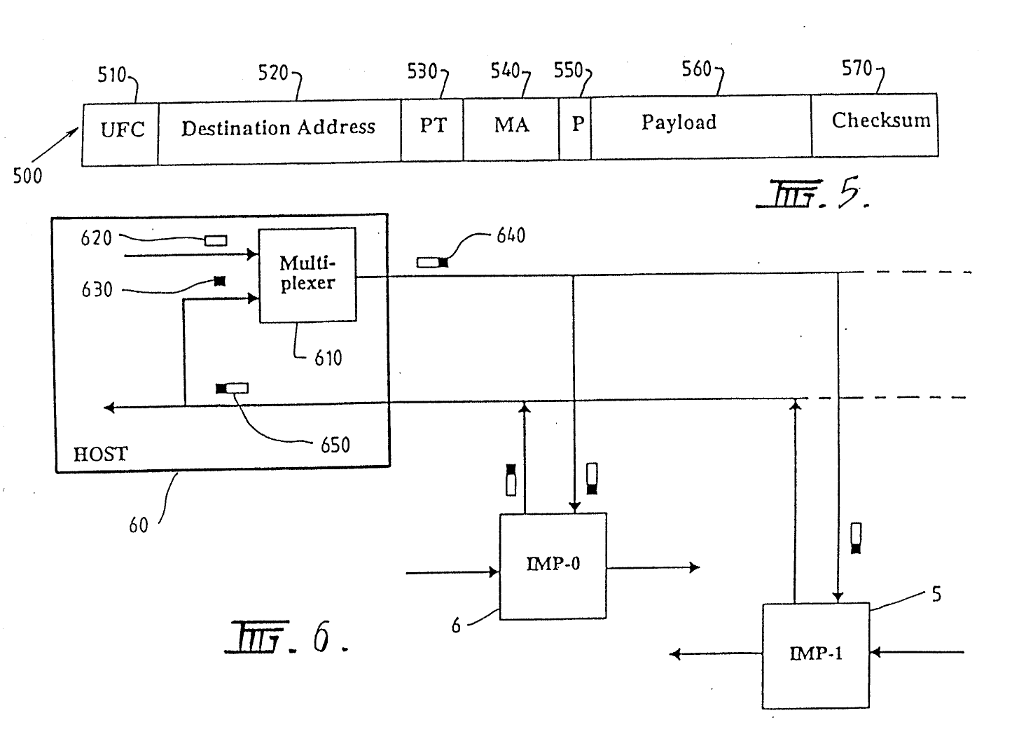

FIG. 5 is a frame structure for messages transmitted between message and most processors;

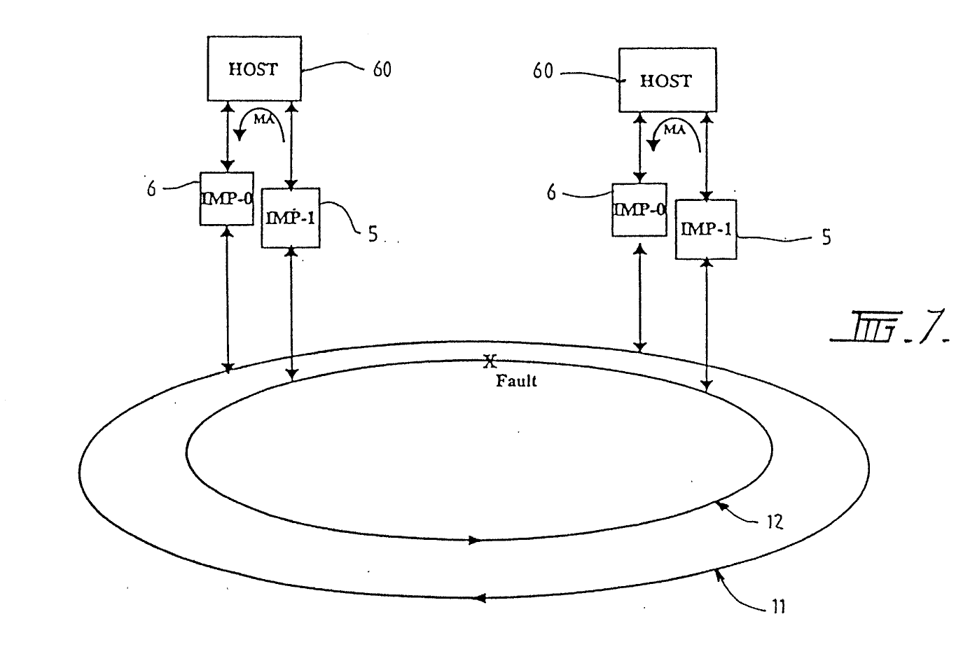

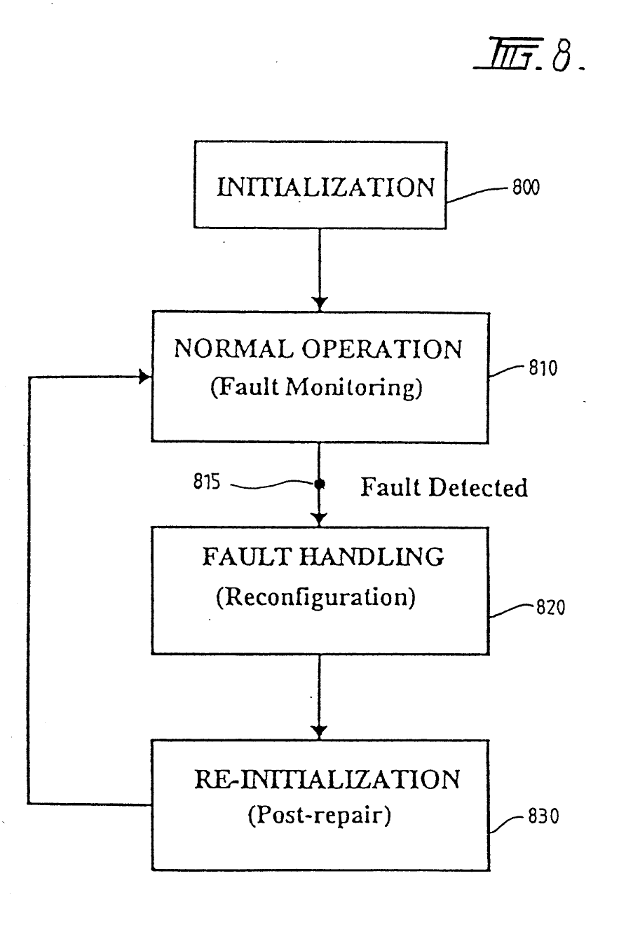

FIG. 6 shows the maintenance (MA) information flow between a host processor and message-processors at a node;

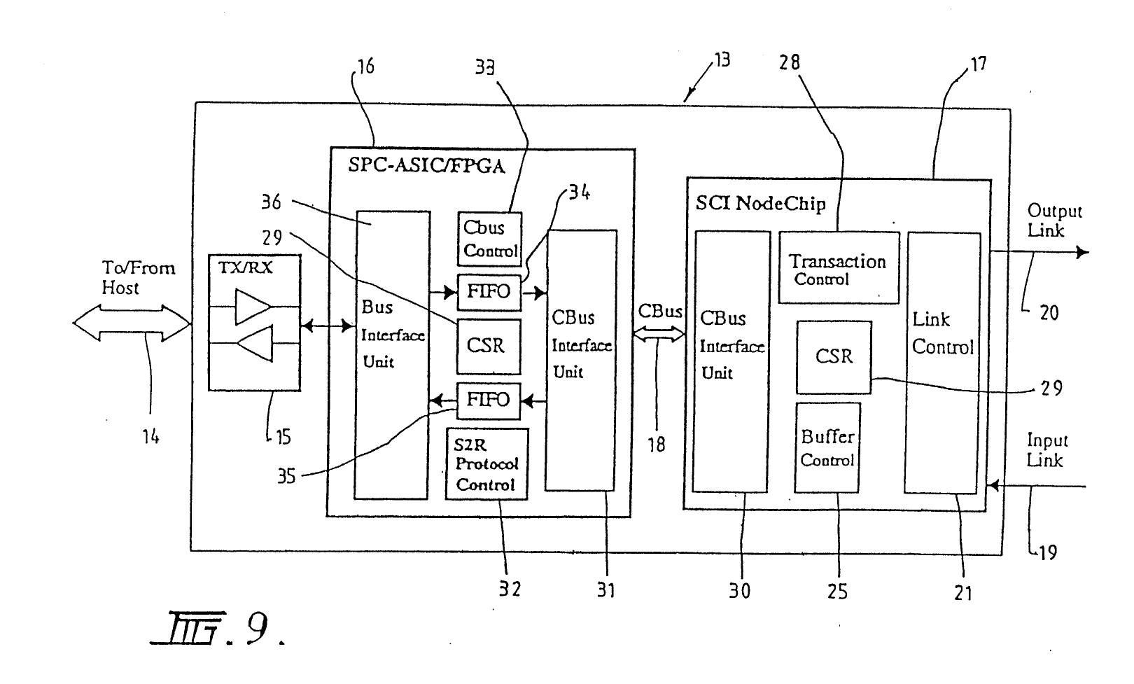

FIG. 7 shows the transfer of maintenance information in the event of a fault occurring in one of the transmission rings of the system;

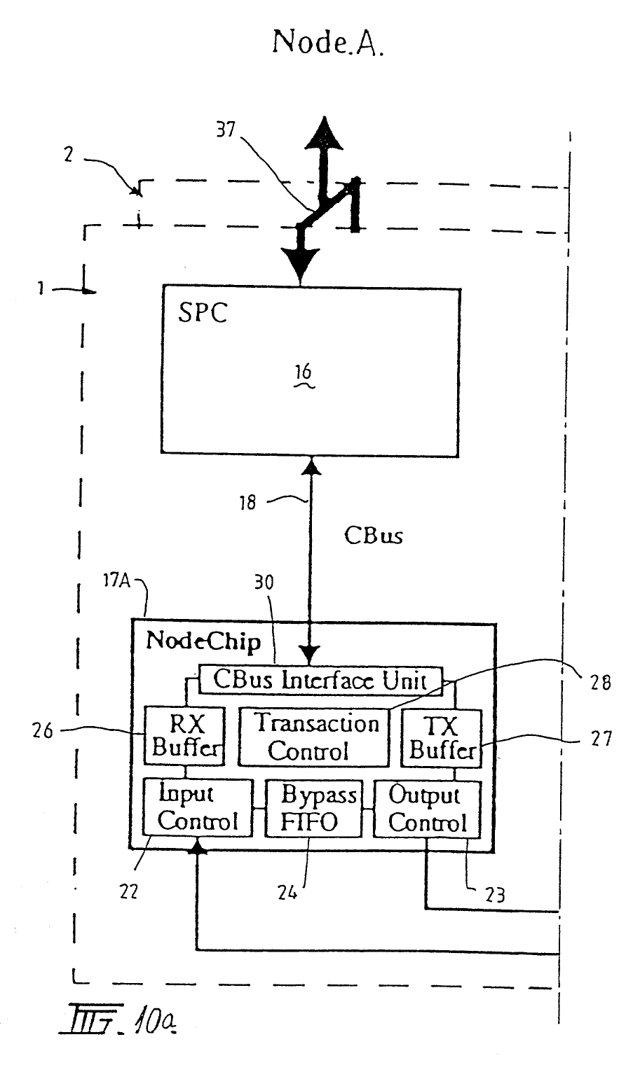

FIG. 8 shows a fault recovery mechanism flow chart when a fault occurs;

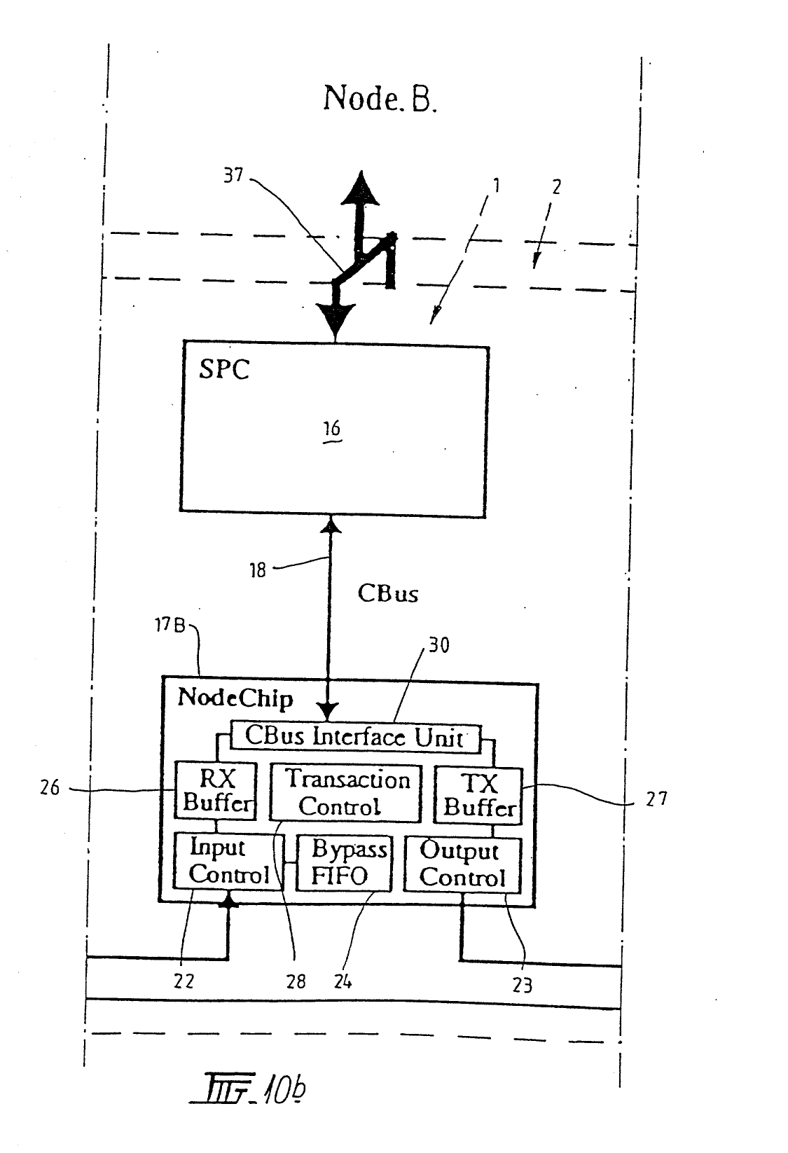

FIG. 9 is a block diagram of the main components of a message processor; and

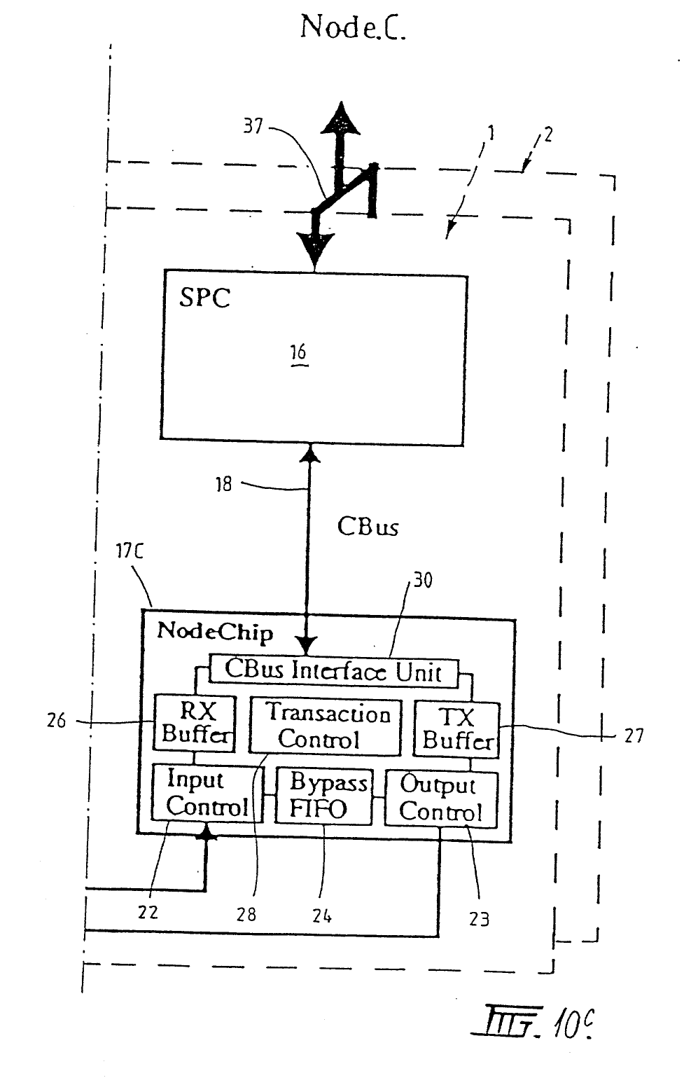

FIG. 10 is a block diagram showing the architecture of a NodeChip interconnection of the transmission rings and the message processors of the system.

Referring to FIG. 1, there is shown a topology of a Scalable Two-Way Ring (S2R) Structure comprising a loop 10 and four nodes, A to D, connected therein. The loop 10 comprises a pair of transmission rings 1 and 2 with each of the nodes A to D connected in the path of each ring 1 and 2. The structure has a scalable architecture which provides for multiple ring-layers so as to cope with various services, capacity and fault tolerances. The particular topology shown in FIG. 1 is an example of a two-layer physical configuration to provide for services and single fault recovery over the same physical layer. In other words, the loop 10 may be considered as two identical ring layers, an inner ring 1 and an outer ring 2.

The loop 10 provides a bus service with packets that it transmits on point-to- point unidirectional links 21 and 22 between the nodes A to D. Each node, A to D, comprises two identical Interface Message Processors (IMPs), labelled 5 and 6, each being connected to a respective ring 11 or 12 of the loop 10. Each node may have more than two IMPs depending on the number of rings required. To deliver a message to its destination node, a host processor at an originating node is required to send the same message to all identical IMPs associated with each ring at the same originating node. The IMPs then decide which ring is to be used to send the message. The decision will be based on the information provided from a Dynamic Look-Up Table in accordance with a Traffic Control process, to be discussed with reference to FIG. 2. The host will sequentially retrieve the message from each of the IMPs, e.g. 5 and 6, on the same node.

As indicated in FIG. 1, the transmission paths of inner ring 1 and outer ring 2 are arranged in opposite directions. In normal operation, the transmission path of data in the inner ring 1 is in a clockwise direction from node A to node D. The transmission path of data in the outer ring 2 is in a counter-clockwise direction from node D to node A. With this two-way arrangement, packets can easily be routed between two adjacent nodes without going through the whole ring 1 or 2, to avoid traffic congestion. For example, when data is to be transmitted from node A to node B it may be transmitted along ring 1 and when data is to be transmitted from node A to node D it may be transmitted along ring 2. However, data may be transmitted from node A to node D along ring 1 when there is less traffic in that ring than in ring 2. It is to be noted that any number of rings may be used, with the rings arranged in a layered structure, and that any number of nodes may be connected within each ring.

In order to handle the non-stop transmitting data between multiple computer processors over the network, a protocol, called the S2R protocol, has been developed on top of SCI protocols in the IMP. The S2R protocol will perform the functions of traffic control and data integrity control.

Traffic Control

In order to provide an efficient routing over the network, the following concepts will be employed:

dynamic table of the traffic control process

traffic balancing

priority routing

force ring.

Whenever a network is set up or a new node is introduced to the network, a dynamic table containing the following will be initiated:

Start Node (Sₙ), being the originating node from which a message is to be transmitted;

End Node (Eₙ), being the destination or termination node for the message;

Ring Identity (R_{id}), corresponding to the rings on which the message can be transmitted;

Node Cost (N_{c}), being the number of ring links a message has to pass through to reach the destination node;

Traffic Loading (T_{ld}), being the number of messages queued for transmission;

Combined Cost (C_{c}), being the sum of N_{c} and T_{ld};

Next Ring Used (NRᵤ), being the next ring chosen to transmit a message, on the basis of a decision of the IMPs using the Traffic Control Process;

Ring Total (Rₜ), being the total number of rings in the network;

Maximum Traffic Load (TLₘ), being a predetermined amount of traffic that the network can handle.

This table will be dynamically updated to reflect the amount of traffic in the network.

Therefore, by implementing the dynamic table of traffic control process, when a packet is received by a local traffic controller in an IMP, it will be able to select the most efficient routing. The steps that the algorithm uses can be demonstrated using the flow chart of FIG. 2.

When a message arrives at step 200, the source address and destination address are set to Sₙ and Eₙ respectively, at step 202, to initiate the search of the dynamic table at step 204. A comparison is then performed at 206 to see if the combined cost, i.e. C_{c}=N_{c}+T_{ld}, has exceeded the limit of TLₘ+N_{c}. If it has exceeded the limit the message is rejected at 208. For example, if the traffic loading T_{ld} exceeds the maximum traffic load TLₘ, when a new message is to be transmitted, that message is rejected. If it does not exceed the limit a decision is made at 210 as to whether all entries returned from the dynamic table have the same combined cost, C_{c}. If they do have the same C_{c}, the traffic balancing concept is applied wherein a comparison is made to see if the Ring Identity, R_{id}, equals the Next Ring Used, NRᵤ, at 212. If it is the same, then that ring is used at 214, and for all entries returned, the traffic loading of that same ring is updated by incrementing the value of T_{ld} by 1, at 216. If R_{id} does not equal NRᵤ then the next ring used is updated by incrementing the value of NR_{ld} by 1 at 218. This will also occur for those returned entries that had R_{id}=NRᵤ. If the next ring used exceeds the total ring Rₜ at 220, the next ring used will be set to 1 at 222 and the process ends at 224. If the next ring used does not exceed Rₜ the process is stopped at 224.

If the combined costs, C_{c}, returned from all the entries are different at 210, then the route that has the minimum cost is chosen at 226. Once a ring is chosen for this route, the traffic loading of that ring is then incremented by 1 at step 228 and the process ends at 224.

An example of a dynamic look-up table that has real time updating during data transmission is shown in the following Tables 1(a)-1(g) with reference to a four node configuration shown in FIG. 3. In FIG. 3, the four nodes are labelled 61, 62, 66 and 69 and the outer and inner rings are labelled 11 and 12 respectively.

TABLE 1(a)
Initial Setup:

| | Start | End | Ring | Node | Traffic | Next | |
|---|---|---|---|---|---|---|---|
| | Node | Node | Identity | Cost | Loading | Ring | Combined |
| Entry | (Sₙ) | (Eₙ) | (R_{id}) | (N_{c}) | (T_{1d}) | (NRᵤ) | Cost (C_{c}) |
| 1 | 61 | 66 | 11 | 1 | 0 | 11 | 1 |
| 2 | 61 | 66 | 12 | 3 | 0 | 11 | 3 |
| 3 | 61 | 62 | 11 | 2 | 0 | 11 | 2 |
| 4 | 61 | 62 | 12 | 2 | 0 | 11 | 2 |
| 5 | 61 | 69 | 11 | 3 | 0 | 11 | 3 |
| 6 | 61 | 69 | 12 | 1 | 0 | 11 | 1 |

A transmission from 61 to 66, Ring #11 is chosen. The updated entries are:

TABLE 1(b)

| | | | | | | | |
|---|---|---|---|---|---|---|---|
| 1 | 61 | 66 | 11 | 1 | 1 | 11 | 2 |
| 2 | 61 | 66 | 12 | 3 | 0 | 11 | 3 |
| 3 | 61 | 62 | 11 | 2 | 1 | 11 | 3 |
| 5 | 61 | 69 | 11 | 3 | 1 | 11 | 4 |

A transmission from 61 to 66, Ring #11 is chosen. The updated entries are:

TABLE 1(c)

| | | | | | | | |
|---|---|---|---|---|---|---|---|
| 1 | 61 | 66 | 11 | 1 | 2 | 11 | 3 |
| 2 | 61 | 66 | 12 | 3 | 0 | 11 | 3 |
| 3 | 61 | 62 | 11 | 2 | 2 | 11 | 4 |
| 5 | 61 | 69 | 11 | 3 | 2 | 11 | 5 |

A transmission from 61 to 66, Ring #11 is chosen. The updated entries are:

TABLE 1(d)

| Entry | Sₙ | Eₙ | R_{id} | N_{c} | T_{1d} | NRᵤ | C_{c} |
|---|---|---|---|---|---|---|---|
| 1 | 61 | 66 | 11 | 1 | 3 | 12 | 4 |
| 2 | 61 | 66 | 12 | 3 | 0 | 12 | 3 |
| 3 | 61 | 62 | 11 | 2 | 3 | 11 | 5 |
| 5 | 61 | 69 | 11 | 3 | 3 | 11 | 6 |

A transmission from 61 to 66, Ring #12 is chosen. The updated entries are:

TABLE 1(e)

| | | | | | | | |
|---|---|---|---|---|---|---|---|
| 1 | 61 | 66 | 11 | 1 | 3 | 12 | 4 |
| 2 | 61 | 66 | 12 | 3 | 1 | 12 | 4 |
| 3 | 61 | 62 | 11 | 2 | 3 | 11 | 5 |
| 4 | 61 | 62 | 12 | 2 | 1 | 11 | 3 |
| 6 | 61 | 69 | 12 | 1 | 1 | 11 | 2 |

A transmission from 61 to 62, Ring #11 is chosen. The updated entries are:

TABLE 1(f)

| | | | | | | | |
|---|---|---|---|---|---|---|---|
| 1 | 61 | 66 | 11 | 1 | 1 | 12 | 2 |
| 3 | 61 | 62 | 11 | 2 | 1 | 12 | 3 |
| 4 | 61 | 62 | 12 | 2 | 0 | 12 | 2 |
| 5 | 61 | 69 | 11 | 3 | 1 | 12 | 4 |

A transmission from 61 to 62, Ring #12 is chosen. The updated entries are:

TABLE 1(g)

| | | | | | | | |
|---|---|---|---|---|---|---|---|
| 2 | 61 | 66 | 12 | 3 | 1 | 12 | 4 |
| 3 | 61 | 62 | 11 | 2 | 1 | 12 | 3 |
| 4 | 61 | 62 | 12 | 2 | 1 | 12 | 3 |
| 6 | 61 | 69 | 12 | 1 | 1 | 12 | 2 |

In Table 1(a) the initial set up shows two entries 1 and 2 for a message to be transmitted from start node 61 to end node 66 along rings 11 and 12 respectively, two entries 3 and 4 for a message to be transmitted from start node 61 to end node 62; and two entries 5 and 6 for a message to be transmitted from start node 61 to end node 6. Initially, the next ring to be used NRᵤ is the outer ring 11 for all entries 1 to 6. For entry 1 the node cost is 1, the traffic loading is initially zero so that the combined cost C_{c}=N_{c}+T_{ld} is 1. For entry 2, the ring identity is ring 12, the node cost is 3 (as it passes along 3 links to get to node 66), the traffic loading is initially zero, so that C_{c}=3.

When a message is required to be transmitted from node 61 to node 66, the next ring used NRᵤ, ring 11 is chosen and the updated entries are shown in table 1(b).

The traffic loading T_{ld} for each entry 1, 3 and 5 for ring 11 is incremented and so the combined cost C_{c} for those entries will also be incremented. As the C_{c} for entry 2 on ring 12 is more than the C_{c} for entry 1 on ring 11 (3 compared to 2 in table 1(b)), then from step 210 in FIG. 2, the next ring to be used for transmitting a message from node 61 to node 66 is that with the minimum C_{c}, i.e. ring 11. That is NRᵤ=11 and the traffic loading is accordingly incremented by one in Table 1(c). As no message is sent on ring 12, the conditions for entry 2 will remain unchanged, i.e. the node cost is still 3 and T_{ld} is still zero.

When the combined costs are compared for entries 1 and 2 in table 1(b), it is seen that C_{c} for entry 2 is still greater than C_{c} for entry 1 (3 to 2). Therefore ring 11 still has the minimum C_{c} and is chosen for the next transmission from node 61 to node 66 in table 1(c). The traffic loading for all entries 1, 3 and 5 for ring 11 is accordingly incremented by 1 to the value of 2 which increases the combined cost to 3. Again, no traffic is transmitted on ring 12 for entry 2 so its C_{c} remains at 3.

We now have the situation where the combined costs for both rings 11 and 12 are equal for entries 1 and 2. When another message is required to be transmitted from node 61 to 66, from step 210 of FIG. 2, the process proceeds to step 212 to see if Rid equals NRᵤ. In this case (refer to table 1(c)), it does and so the message is transmitted on the same ring, i.e. ring 11 and the T_{ld} for ring 11 is incremented by 1 to the value of 3 as seen in table 1(d) for entry 1. The next ring used NRᵤ for entries 1 and 2 is then updated to ring 12 in table 1(d).

A new message to be sent from start node 61 to end node 66 will now be transmitted on ring 12 and the values of T_{ld} and C_{c} for entries 2, 4 and 6 are incremented as shown by Table 1(e).

For entries 2, 4 and 6 the traffic loading is updated to 1. The traffic loading for entry 1 remains at 4 as it has now changed rings.

To analyze a transmission from node 61 to node 62, it is necessary to consider initial values for entries 3 and 4 in table 1(a). From table 1(a) ring 11 is used for entries 3 and 4 and the combined costs are equal. For entry 3, R_{id}=NRᵤ so ring 11 is used and the updated entries for T_{ld} and NRᵤ are shown in table 1(f). For entry 4, R_{id}≠NRᵤ and therefore just NRᵤ is updated by 1 to 12. When another message is required to be sent from start node 61 to end node 62, as seen in table 1(f), the combined cost for entry 3 is 3 which is greater than the combined cost for entry 4, which is 2. Therefore ring 12 is selected and the updated entries are shown in table 1(g). The T_{ld} for entry 4 is updated to 1.

When a packet of data is deemed to be important and requires immediate transmission, the priority routing concept can be employed. This will ensure that a packet with a high priority can by-pass the normal rule of routing and get to the destination as soon as possible. For example, if a packet is queued for transmission at node 61 and intended for node 66 along inner ring 11, if it has priority over other packets queued ahead of it, then that priority packet may be transmitted to node 66 along ring 12 provided that this is the most expeditious path.

The force ring scheme can be used to delegate a task to a particular ring. That is, a selected ring will only be used to transmit particular specified messages while the other ring will carry the remainder of the traffic. It is particularly useful when there is a large amount of data required to transfer from one node in the network to another node.

Data Integrity Control

To ensure the message is transmitted correctly and accurately within the network, Message Verification and Message Sequencing will be utilized during the transmission.

A Checksum, Address Validation and Message Length Check will be used for the Message Verification. When a host processor sends a message to the IMPs, there must be a Checksum attached to the message. Each IMP makes its own calculation and compares it to the Checksum received in the message. If there is a mismatch, the message is discarded and an error signal will be issued to the host.

To ensure the Message Sequencing, a User-defined Flow Control (UFC) concept will be used with the following rules:

When a message is sent from the host to IMP, there are two services to be provided by IMP, i.e. Acknowledgement of message (AKM) and Retransmission of message (RTM). With these two services, three situations could happen:

(1) when the host does not require AKM, the IMP will continue to send the next message after sending the existing message.

(2) when the host requires AKM and RTM, the IMP will keep a copy of the message and retransmit the message when the Acknowledgement (ACK) is not received from the receiving node within a time-period (T_{ack}). This will be repeated until the maximum Resend Count (RCₘ) is reached, in which case an error signal will be issued to the host.

(3) when the host requires AKM and no RTM, the IMP will send an error signal to the host if the timeout T_{ack} expires while awaiting for ACK response and the IMP can continue to send next message.

Whenever a message is received in the IMP of the receiving node, a response ACK will be generated and returned to the sending node. If the message is faulty in some way, the message will be discarded and no response will be generated.

Both the value of the timeout T_{ack} and the RCₘ are programmable from the host by setting the Control and Status Registers (CSR) in IMP.

Network Maintenance

The maintenance in the network is distributed and has a layered structure. Maintenance functions are carried out within each IMP of each node in relation to resources and parameters residing in the network's protocol entities. With reference to FIG. 4, each IMP 5, 6 includes a S2R maintenance module 410 for performing S2R maintenance functions and an SCI maintenance module 420 for performing SCI maintenance functions. Between the S2R maintenance modules and the maintenance software in each host processor 60, there is established an S2R protocol which can implement the functions when necessary. A local processor bus protocol is established between the S2R and SCI maintenance modules 410 and 420. Between the transmission rings 11, 12 and the SCI maintenance modules, there is established an SCI protocol which again can implement the necessary functions when required. For each layer, the layer maintenance handles the specific maintenance information flows and provides the services to the upper layer.

In FIG. 5 there is shown the frame structure 500 for a message transmitted between a host processor 60 and its associated IMPs 5, 6. The first field of bits 510 is reserved for the User-defined Flow Control (UFC), the coding and functionality of the bits being determined depending on the user application. The second field 520 is the destination address field, the bits indicating address data relevant to the destination node. The PT field 530 designates the Payload Type and is coded in 2 bits indicating the type of message including the data message, command message and the idle message. The Maintenance (MA) field 540 of 4 bits carries the information related to side identifier, fault and traffic status. The Priority (P) field 550 indicates whether or not a message has priority over other messages to be transmitted. The Payload Field 560 contains the actual data to be transmitted or command data such as for the dynamic look-up table, or for the CSR during initialisation. The last field 570 is reserved for the Checksum for message verification.

FIG. 6 shows information flow relating to the maintenance (MA) between the host and the message processors 5, 6. When a message is transmitted from the host 60 to any of message processors 5 and 6, packets 620 have the maintenance information bits (MA) 630 attached to them via multiplexer 610. The MA field is placed in the frame header resulting in the combined packet 640 being transmitted. On receiving a message, for example packet 650, the host 60 will extract or strip the MA bits 630 from each packet 650 and place the maintenance bits in the MA field of the next outgoing message.

SCI Maintenance Functions

All packets transmitted on the rings are covered by a Cyclic Redundancy Check (CRC). That is, any CRC errors are detected in each node and reported to S2R maintenance subsystem.

When sending a packet, the node will expect an acknowledgement to occur within a timeout period. If the sender does not receive the acknowledgement within this timeout period, it will increment the fault counter and cause the Status bit of Echo timeout to be asserted. Retransmission might then be done dependent on the application of the maintenance software.

When a ring is operational, synchronization packets will be sent on the down stream link within a given interval. If this interval becomes too long or the synchronization packets for some reason do not occur, it will cause a synchronization error to be flagged by the down stream node. Restart of the ring might then be performed dependent on the maintenance software. The restart sequence of the ring is handled by the SCI protocols.

S2R Self-Recovery Mechanism

The IMP defines a working mode and a protection mode. In normal operation, the IMP is configured in a working mode. If a fault X is detected, say on ring 12 of the network shown in FIG. 7, the MA bits will be sent from IMP 5, connected in the faulty ring 12, via its host processor 60 to the other IMP 6 associated with each particular node so that transmission can resume on ring 11. In this way the IMP is reconfigured in a protection mode whereby all packets can be transmitted on the fault-free ring 11. This fault recovery mechanism is normally expected to be handled by S2R maintenance functions as shown in FIG. 8. Under normal operation the maintenance functions monitor each IMP for faults at step 810, and if a fault 815 is detected at 815, the maintenance functions are invoked to reconfigure the IMP to the protection mode at 820. The IMP is re-initialized at 830 when repairs have been carried out to remove the fault.

The particular procedure will be as follows:

If a signal to be transmitted fails, resend or re-transmit the signal. This will be handled by SCI maintenance functions.

If the resending fails, initiate tests of the IMP and ring to locate faults, and then switch the traffic to the other ring. This will be handled by 2SR maintenance functions.

If both fail, restart all IMPs. This shall be handled by maintenance software.

There must be some routine test in place in each IMP, so that all IMPs can perform the restart if both rings fail.

Node installation or node replacement will not affect the normal traffic over the network. Each host will send a command message to IMPs to update the dynamic look-up table and CSR after the new node has been installed. The IMP of the new ring will send MA bits to the other side to take over the traffic, the old ring can then be disconnected and installed with the new IMP for the new node. After the new node is installed and attached to both rings, each IMP of the working ring (i.e. protection node) will gradually send MA bits to the other side of IMP to reconfigure both sides as working mode. The same procedure will also be applied to the node replacement except the update of the dynamic table.

Implementation

Each IMP, shown as 13 in FIG. 9, comprises three main parts, a transmitter/receiver section 15, a S2R Protocol Controller (SPC) 16 and an SCI NodeChip 17.

The SPC 16 contains digital logic in a single Application Specific Integrated Circuit/Field Programmable Gate Array (ASIC)/(FPGA) which performs the protocol conversion functions between the NodeChip 17 and a host processor (not shown). The host processor communicates with IMP 13 through processor bus 14 and is specifically linked to the transmitter/receiver section 15 of the IMP 13.

Node-to-Node interconnection is implemented using the SCI NodeChip 17, which is a single-chip solution complaint with the physical and logical layers of the SCI standard as defined in the American National Standards Institute/Institute of Electrical and Electronics Engineers (ANSI/IEEE) Standard 1596-1992. The NodeChip is a Trade Mark of Dolphin Internconnect Solutions and its functions are explained in technical reference manual of the manufacturer.

The SCI NodeChip 17 is implemented in low-power, CMOS technology. It provides an input link 19 and output link 20 for unidirectional communication suitable for node-to-node ring topologies. A 64-bit bidirectional bus 18, called CBus, provides a communication path between the SCI NodeChip 17 and SPC 16. The link control unit 21 of NodeChip 17 comprises an input control 22 for receiving packets of data from other IMPs, an output control 23 for transmitting packets from its respective IMP to other IMPs on the same ring, and a bypass first in first out (FIFO) buffer 24 connected between each input control 22 and output control 23 of the NodeChips 17 associated with each IMP.

FIG. 10 shows the architecture of an S2R loop having two ring layers 1 and 2 with three nodes A, B and C in which the output control 23 of a first NodeChip 17A is connected via a link 21 of a transmission ring to the input control 22 of the 17B associated with a neighbouring node B on the same ring layer 1 and so on until the ring is complete. The output control 23 of the NodeChip 17C of the last node C in the ring is linked to the input control of the first IMP NodeChip 17A. The bypass FIFO 24 is connected between the input control 22 and output control 23 of each NodeChip 17.

Buffer control 25 oversees the control of storing and queuing packets of data that have been received in RX buffer 26 and those packets stored and queued ready for transmission in the TX buffer 27. Each of the NodeChip 17 and SPC 16 has a CBus Interface Unit 30 and 31 respectively for translating the packets and signals transmitted and received on CBus 18 into a format suitable for use respectively by the NodeChip 17 and SPC 16. The Control and Status Registers (CSR) 29 store data for carrying specified tasks within the IMP and the host.

The SPC 16 interfaces the SCI NodeChip 17 to the host processor and translates read and write transactions supported by the NodeChip 17 to transfer data between the host processor bus 14 and the remote S2R nodes. The protocol conversion functions between the NodeChip 17 and host processor are carried out under the control of S2R Protocol Control Unit 32. CBus control unit 33 oversees the control of data transmitted over and received from the CBus 18. FIFO buffers 34 and 35 stack the packets of data being transmitted to and received from the host and NodeChip 17 on a first-in first-out basis. The buffers are connected between CBus Interface Unit 31 and Bus Interface Unit 36 which receives and transmits the data packets to the IX/RX section 15.

A two-byte wide differential pseudo-ECL signal provides the link speed between the nodes of 125 Mbytes/s. To overcome the physical limitation of the node-to-node distance a Hewlett Packard G-Link HDMP-1000 parallel-to-serial chipset is used. The NodeChip can directly interface to this chipset to achieve 1 Gbit/s serial coaxial communication over distances of tens of metres.

As seen in FIG. 10, the interconnection of each of the IMPs associated with a particular node is done through a processor bus 37, where each associated IMP is on a different ring layer. This enables each node to select the most appropriate ring to use to transmit a particular message.

The embodiment described hereinabove has disclosed a Scalable Two-Way Ring (S2R) architecture that uses the SCI technology to produce a highly reliable self-recovery ring system. A simple self-recovery procedure has been described based on the SCI protocols and leads to a rapid recovery from transmission line failure. The S2R protocol has the advantages of scalability, modularity, rapid self-recovery and real-time node installation and replacement. A dynamic traffic control algorithm has been described which enhances the utilisation of the dual-ring capacity. The user-defined flow control scheme handles the data sequencing while force ring and priority routing schemes provide the user the flexibility of the ring system. Furthermore, the maintenance information flow scheme avoids the physical connections between the IMPs as well as providing a cost-effective transfer of maintenance information over the ring system. The described embodiment discloses a dual ring loop or system using a commercial SCI chipset. Clearly, because of its scalable architecture it can be designed in multiple loop layers to cope with various services, capacity and fault tolerance.

The dual ring architecture has the ability to recover rapidly from transmission line failure by having an alternative ring-layer and a simple recovery procedure. If one ring goes down the other will take over its work at reduced performance, but the system can still maintain a certain degree of traffic until the faulty part is fixed and brought back into operation. For military, banking, telecommunication and many other applications, the ability to continue operating in the face of hardware problems is of great importance.

Since modifications within the spirit and scope of the invention may be readily effected by persons skilled in the art, it is to be understood that the invention is not limited to the particular embodiment described, by way of example, hereinabove.

1. A method of transmitting data between a plurality of nodes containing computer processors, said method including the steps of:
connecting the nodes by a plurality of unidirectional transmission rings such that each ring is in a closed loop configuration, said transmission rings being arranged to transmit data between the nodes in alternately opposed directions around the rings;
dynamically monitoring the traffic of data in each ring to obtain traffic information in each ring; and
utilising said traffic information to select one of the rings to transmit data in accordance with certain criteria.

2. A method according to claim 1 wherein the rings are arranged in a layered structure and each node includes a plurality of message processors, one for each transmission ring.

3. A method according to claim 2 wherein each node includes a host processor linked to the message processors of the node.

4. A method according to claim 3 wherein when a host processor is required to transmit a data message from its originating node to a destination node, the data message is sent from the host processor to each message processor associated with that originating node and the message processors of the originating node select a ring to transmit the data on the basis of the monitored information.

5. A method according to claim 4 wherein said each message processor associated with the originating node performs its selection on the basis of information obtained from a look-up table in accordance with a traffic control process.

6. A method according to any one of claims 1 to 5 wherein said monitoring step includes monitoring each ring to obtain information on any one or more of the following: the available ring capacity; data flow rate on each ring; and monitoring of faults.

7. A method according to claim 6 wherein said selection is made in response to any one or more of the following: the available ring capacity; data flow rate on each ring; and fault identification.

8. A method according to any one of the preceding claims wherein said method utilizes Scalable Coherent Interface (SCI) technology.

9. A method according to any one of the preceding claims wherein the transmission of data messages between the nodes is controlled by a protocol.

10. A method according to claim 9 wherein the protocol controls the traffic of data in each of the transmission rings and controls the integrity of the data transmission between the computer processors of the nodes.

11. A method according to claim 10 wherein the protocol is implemented in each of the processors of each node and controls the selection of a ring on which to transmit data messages, said selection being made on the basis of information obtained from a look-up table in accordance with a traffic control process.

12. A method according to claim 5 or claim 11 wherein the look-up table is dynamically updated for each new data message to be sent.

13. A method according to any one of the preceding claims wherein the traffic loading on each ring is used to determine the ring that is selected to be used to transmit a data message.

14. A method according to any one of the preceding claims wherein the number of ring links along which a data message has to travel between nodes to reach its destination is used to determine the ring that is selected to be used to transmit the data message.

15. A method according to any one of the preceding claims wherein the processors are arranged to carry out maintenance functions.

16. A method according to claim 15 wherein, in the event of a fault occurring on one ring, the data messages are transmitted only on the ring or rings not affected by the fault.

17. A method according to claim 16 wherein, in the event of a fault occurring in one ring, maintenance bits associated with data packets being transmitted or queued for transmission on the faulty ring, are transferred to other processors at each node so that transmission of the affected packets can continue on other rings not affected by a fault.

18. A method according to any one of the preceding claims comprising the further steps of determining whether data to be transmitted is priority data containing priority information and selecting one of the rings to transmit said priority data so as to provide the most expeditious route for said priority data to reach the destination node.

19. A method according to any one of the preceding claims further comprising the steps of selecting one ring on which to transmit data of a particular kind and transmitting all other data on another ring or other rings.

20. A method of transmitting data between a plurality of nodes containing computer processors, said method including the steps of:
connecting the nodes by a plurality of unidirectional transmission rings, each ring being in a closed loop configuration, said transmission rings being arranged to transmit data around the rings between the nodes in alternately opposed directions;
determining whether data to be transmitted contains priority information; and
selecting one of the rings to transmit said data so as to provide the most expeditious route for the data to reach a destination node.

21. A method according to claim 18 or claim 20 wherein said determining step is performed by reading packets of data to see if a priority field in the packets is flagged indicating that it has priority.

22. A method according to claim 21 wherein packets of data having priority and queued for transmission will be transmitted ahead of packets queued for transmission that do not have priority.

23. A method of transmitting data between a plurality of nodes containing computer processors, said method including the steps of:
connecting the nodes by a plurality of unidirectional transmission rings, each ring being in a closed configuration and said transmission rings each arranged to transmit data in alternately opposed directions around the rings between the nodes;
selecting one ring on which to transmit data of a particular kind; and
transmitting all other data on another ring or other rings.

24. A communications system for transmitting data between a plurality of nodes in a network, comprising:
a closed loop configuration of two or more unidirectional transmission rings connecting the nodes, the transmission rings being arranged to transmit data between the nodes in alternately opposed directions around the rings;
each node including a respective message processor for each of the transmission rings;
wherein the message processors are programmed to select one of the rings to be used for transmitting a message from a node to another node in accordance with certain criteria.

25. A communications system according to claim 24 wherein each node contains a host processor which is linked to the message processors of the node.

26. A communications system according to claim 24 or claim 25 wherein the host processor at an originating node is arranged to send a data message to each of the message processors at the originating node, and the message processors then select which ring is to be used to send the message.

27. A communications system according to claim 26 wherein the message processors at an originating node are programmed to select the ring to be used on the basis of information obtained from a look-up table.

28. A communications system according to claim 27, wherein the look-up table is dynamically updated for each new data message to be sent.

29. A communications system according to any one of claims 24 to 28 including fault detection means for detecting when faults occur in the transmission rings.

30. A communications system according to claim 29 wherein when a fault is detected in one of the transmission rings, the system is arranged to transmit data messages only on the ring or rings not affected by the fault.

31. A communications system according to any one of the preceding claims wherein the transmission rings are arranged in a layered configuration of at least one pair of unidirectional rings arranged to transmit data in opposite directions around the rings.

32. A communications system according to any one of claims 24 to 31 wherein each message processor comprises a scalable coherent interface.
